(19) United States
(12) Patent Application Publication
(10) Pub. No.: US 2024/0409788 A1
(43) Pub. Date: Dec. 12, 2024

(54) PRESSURE-SENSITIVE ADHESIVE COMPOSITION AND PRESSURE-SENSITIVE ADHESIVE SHEET USING SAID PRESSURE-SENSITIVE ADHESIVE COMPOSITION

(71) Applicant: NITTO DENKO CORPORATION, Ibaraki-shi, Osaka (JP)

(72) Inventors: Satoshi HONDA, Ibaraki-shi, Osaka (JP); Yusuke TAKEDA, Ibaraki-shi, Osaka (JP); Kenta KUMAKURA, Ibaraki-shi, Osaka (JP); Naofumi KOSAKA, Ibaraki-shi, Osaka (JP); Tomokazu TAKAHASHI, Ibaraki-shi, Osaka (JP)

(21) Appl. No.: 18/697,099

(22) PCT Filed: Sep. 21, 2022
(86) PCT No.: PCT/JP2022/035085

§ 371 Date: Mar. 29, 2024

(30) Foreign Application Priority Data
Sep. 29, 2021 (JP) 2021-160103

(51) Int. Cl. C09J 7/38; C09J 11/06; C09J 133/10

(52) U.S. Cl. CPC C09J 7/385; C09J 11/06; C09J 133/10

(57) ABSTRACT

The present invention provides a pressure-sensitive adhesive composition having an excellent adhesive force when bonding to an adherend, having excellent peelability when subjected to batch heat treatments at a high temperature, and having both a high initial adhesive force and a low post-heating adhesive force. The pressure-sensitive adhesive composition according to the present invention contains: a material having a radically polymerizable functional group; and a thermal polymerization initiator that generates a radical, in which a content of the thermal polymerization initiator is 1.2 to 10 parts by mass with respect to 100 parts by mass of all components excluding the thermal polymerization initiator.

### TECHNICAL FIELD

The present invention relates to a pressure-sensitive adhesive composition, and a pressure-sensitive adhesive sheet using the pressure-sensitive adhesive composition.

### BACKGROUND ART

In the related art, pressure-sensitive adhesive sheets such as a pressure-sensitive adhesive tape and a pressure-sensitive adhesive label have been used in various fields. For example, when a heat treatment is performed in the production of various industrial products, a pressure-sensitive adhesive sheet is bonded to a portion to be avoided from direct heating, and the pressure-sensitive adhesive sheet is peeled from the surface of an adherend after the heat treatment.

As such a pressure-sensitive adhesive sheet in the related art used for heat-resistant masking, those containing a carbon-based polymer in a pressure-sensitive adhesive layer are used. When it is heated at a high temperature of 160° C. or higher together with an adherend such as a glass or a metal, the attraction of an intermolecular force of carbon becomes strong, and the pressure-sensitive adhesive layer may be attracted to the surface of the adherend, causing an adhesive residue or making it difficult to peel the pressure-sensitive adhesive sheet. For example, Non Patent Literatures 1 and 2 discloses that various polymers have an attraction force when heated.

In addition, a pressure-sensitive adhesive sheet having a pressure-sensitive adhesive layer containing an acrylic polymer as a main component is widely used because of having excellent adhesiveness and also having heat resistance when crosslinked. For example, Patent Literatures 1 to 4 propose a thermosetting pressure-sensitive adhesive composition containing an acrylic polymer.

### CITATION LIST

### Patent Literature

Patent Literature 1: JP2015-29105A
Patent Literature 2: JP2016-204617A
Patent Literature 3: JP2019-56101A
Patent Literature 4: JPH10-209087A

### Non-Patent Literature

Non Patent Literature 1: Simone Napolitano, ‘Irreversible adsorption of polymer melts and nanoconfinement effects’, Soft Matter, 2020, 16, pp. 5348-5365
Non Patent Literature 2: Ben O'Shaughnessy and Dimitrios Vavy lonis, ‘Non-equilibrium in adsorbed polymer layers’, J. Phys.: Condens. Matter, 17, 2005, pp. R63-R99

### SUMMARY OF INVENTION

### Technical Problem

A pressure-sensitive adhesive sheet having heat resistance are required not only to have an adhesive force to the adherend but also to be easily peeled after a heat treatment. For the pressure-sensitive adhesive compositions in Patent Literatures 1 to 4, it is difficult to control the balance between curing and attraction of a pressure-sensitive adhesive layer when the pressure-sensitive adhesive composition is subjected to batch heat treatments at a high temperature of 160° C. or higher.

Therefore, an object of the present invention is to provide a pressure-sensitive adhesive composition having an excellent adhesive force when bonding to an adherend, having excellent peelability when subjected to batch heat treatments at a high temperature, and having both a high initial adhesive force and a low post-heating adhesive force.

### Solution to Problem

As a result of extensive research, the inventors of the present invention have found that the above problem can be solved by a pressure-sensitive adhesive composition containing a material having a radically polymerizable functional group and a specific amount of a thermal polymerization initiator that generates a radical. Thus, the present invention has been completed.

That is, the present invention relates to the following (1) to (12).

(1) A pressure-sensitive adhesive composition containing:
a material having a radically polymerizable functional group; and
a thermal polymerization initiator that generates a radical, in which
a content of the thermal polymerization initiator is 1.2 to 10 parts by mass with respect to 100 parts by mass of all components excluding the thermal polymerization initiator.

(2) The pressure-sensitive adhesive composition according to the above (1), in which the thermal polymerization initiator contains at least one of a peroxide and an azo-based compound.

(3) The pressure-sensitive adhesive composition according to the above (1) or (2), in which the thermal polymerization initiator has a 1-minute half-life temperature of 100° C. to 150° C.

(4) The pressure-sensitive adhesive composition according to any one of the above (1) to (3), in which the thermal polymerization initiator has a 10-hour half-life temperature of 60° C. to 100° C.

(5) The pressure-sensitive adhesive composition according to any one of the above (1) to (4), in which the material having a radically polymerizable functional group is at least one of a polymer having a radically polymerizable functional group and a monomer having a radically polymerizable functional group.

(6) The pressure-sensitive adhesive composition according to any one of the above (1) to (5), in which the radically polymerizable functional group is a (meth)acryloyl group.

(7) The pressure-sensitive adhesive composition according to the above (5) or (6), in which the polymer having a radically polymerizable functional group is contained as a base polymer.

(8) The pressure-sensitive adhesive composition according to the above (7), in which the base polymer is an acrylic polymer.

(9) The pressure-sensitive adhesive composition according to any one of the above (1) to (8), further containing: a surfactant.

(10) The pressure-sensitive adhesive composition according to the above (9), in which the surfactant is a nonionic surfactant.

(11) A pressure-sensitive adhesive sheet including:

a pressure-sensitive adhesive layer formed of the pressure-sensitive adhesive composition according to any one of the above (1) to (10).

(12) A peeling method for peeling the pressure-sensitive adhesive sheet according to the above (11) which is bonded to an adherend, the peeling method including:

a step of subjecting the adherend to which the pressure-sensitive adhesive sheet is bonded to a heat treatment at 160° C. to 250° C. for 3 minutes to 5 hours without a prior heat treatment at 100° C. or higher, and then peeling the adherend and the pressure-sensitive adhesive sheet at an interface therebetween.

### Advantageous Effects of Invention

Since the pressure-sensitive adhesive composition according to the present invention can achieve both a high initial adhesive force and a low post-heating adhesive force, a pressure-sensitive adhesive sheet including a pressure-sensitive adhesive layer made from the pressure-sensitive adhesive composition according to the present invention has excellent adhesiveness to an adherend, and also has excellent peelability that allows easy peeling without causing heavy peeling when subjected to batch heat treatments at a high temperature of 160° C. or higher.

### DESCRIPTION OF EMBODIMENTS

Hereinafter, embodiments of the present invention will be described in more detail, but the present invention is not limited to the following embodiments.

Note that, in the present description, “(meth)acrylic” refers to acrylic and/or methacrylic, and similarly, “(meth)acryloyl” refers to acryloyl and/or methacryloyl, and “(meth)acrylate” refers to acrylate and/or methacrylate.

In addition, in the present description, “mass” has the same meaning as “weight”.

### [Pressure-Sensitive Adhesive Composition]

A pressure-sensitive adhesive composition according to an embodiment of the present invention contains: a material having a radically polymerizable functional group; and a thermal polymerization initiator that generates a radical, in which the thermal polymerization initiator is contained in an amount of 1.2 to 10 parts by mass with respect to 100 parts by mass of all components excluding the thermal polymerization initiator.

In the present invention, the radically polymerizable functional group refers to a group having a carbon-carbon double bond and capable of radical polymerization. The material having a radically polymerizable functional group may be contained in a base polymer or may be a component other than the base polymer.

### (Base Polymer)

The base polymer in the pressure-sensitive adhesive composition according to the present embodiment refers to a main component of a polymer contained in the pressure-sensitive adhesive composition. In the present description, unless otherwise specified, the “main component” refers to a component contained in an amount of more than 50 mass %, preferably 60 mass % or more, and more preferably 70 mass % or more.

The type of the base polymer for use in the present embodiment is not particularly limited, and examples thereof include various polymers that exhibit rubber elasticity at a room temperature range, for example, an acrylic polymer, a rubber-based polymer (natural rubber, synthetic rubber, or a mixture thereof), a polyester-based polymer, a urethane-based polymer, a polyether-based polymer, a silicone-based polymer, a polyamide-based polymer, and a fluorine-based polymer. These may be used alone or in combination of two or more types thereof. Among them, an acrylic polymer is preferably used. When an acrylic polymer is used, it is possible to obtain a pressure-sensitive adhesive sheet having an excellent balance between an adhesive force and peelability.

The acrylic polymer generally contains an alkyl (meth)acrylate as a main component as a monomer unit.

Examples of the alkyl (meth)acrylate that constitutes a main skeleton of the acrylic polymer include those having a linear or branched alkyl group having 1 to 18 carbon atoms. Examples of the alkyl group include a methyl group, an ethyl group, a propyl group, an isopropyl group, a butyl group, an isobutyl group, an amyl group, a hexyl group, a cyclohexyl group, a heptyl group, a 2-ethylhexyl group, an isooctyl group, a nonyl group, a decyl group, an isodecyl group, a dodecyl group, an isomyristyl group, a lauryl group, a tridecyl group, a pentadecyl group, a hexadecyl group, a heptadecyl group, and an octadecyl group. These can be used alone or in combination. The average number of carbon atoms of these alkyl groups is preferably 1 to 9.

A monomer containing a polar functional group such as a hydroxy group, a carboxy groups, an amino group, or an amide group can be used as the monomer unit in the acrylic polymer.

The hydroxy group-containing monomer is a compound that contains a hydroxy group in the structure and that also has a polymerizable unsaturated double bond such as a (meth)acryloyl group or a vinyl group. Specific examples of the hydroxy group-containing monomer include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxyaryl (meth)acrylate, and (4-hydroxymethylcyclohexyl)-methyl acrylate. Among the hydroxy group-containing monomers, 2-hydroxyethyl (meth)acrylate and 4-hydroxybutyl (meth)acrylate are preferred from the viewpoints of durability, copolymerizability, price, and adhesive properties (such as adhesive strength).

The carboxy group-containing monomer is a compound that contains a carboxy group in the structure and that also has a polymerizable unsaturated double bond such as a (meth)acryloyl group or a vinyl group. Specific examples of the carboxy group-containing monomer include (meth)acrylic acid, carboxyethyl (meth)acrylate, carboxypentyl (meth)acrylate, itaconic acid, maleic acid, fumaric acid, and crotonic acid. Among the carboxy group-containing monomers, acrylic acid is preferred from the viewpoints of durability, copolymerizability, price, and adhesive properties (such as adhesive strength).

The amino group-containing monomer is a compound that contains an amino group in the structure and that also has a polymerizable unsaturated double bond such as a (meth)acryloyl group or a vinyl group. Specific examples of the amino group-containing monomer include aminoethyl (meth)acrylate, N,N-dimethylaminoethyl (meth)acrylate, and N,N-dimethylaminopropyl (meth)acrylate.

The amide group-containing monomer is a compound that contains an amide group in the structure and that also has a polymerizable unsaturated double bond such as a (meth)acryloyl group or a vinyl group. Specific examples of the amide group-containing monomer include: acrylamide-based monomers such as (meth)acrylamide, N,N-dimethyl (meth)acrylamide, N,N-diethyl (meth)acrylamide, N-isopropyl acrylamide, N-methyl (meth)acrylamide, N-butyl (meth)acrylamide, N-hexyl (meth)acrylamide, N-methylol (meth)acrylamide, N-methylol-N-propane (meth)acrylamide, aminomethyl (meth)acrylamide, aminoethyl (meth)acrylamide, mercaptomethyl (meth)acrylamide, and mercaptoethyl (meth)acrylamide: N-acryloyl heterocyclic monomers such as N-(meth)acryloylmorpholine, N-(meth)acryloylpiperidine, N-(meth)acryloylpyrrolidine; and N-vinyl group-containing lactam monomers such as N-vinyl-pyrrolidone and N-vinyl-8-caprolactam. The amide group-containing monomer is preferred from the viewpoint of satisfying the durability, and among the amide group-containing monomers, a N-vinyl group-containing lactam monomer is particularly preferred.

For the acrylic polymer, an aromatic ring-containing (meth)acrylate can also be used. The aromatic ring-containing (meth)acrylate is a compound that has an aromatic ring structure in the structure and that also contains a (meth)acryloyl group. Examples of the aromatic ring include a benzene ring, a naphthalene ring, and a biphenyl ring. The aromatic ring-containing (meth)acrylate satisfies the durability and can reduce display unevenness due to white spots in a peripheral portion. Specific examples of the aromatic ring-containing (meth)acrylate include those having a benzene ring, such as benzyl (meth)acrylate, phenyl (meth)acrylate, o-phenylphenol (meth)acrylate phenoxy (meth)acrylate, phenoxyethyl (meth)acrylate, phenoxypropyl (meth)acrylate, phenoxy diethylene glycol (meth)acrylate, ethylene oxide-modified nonylphenol (meth)acrylate, ethylene oxide-modified cresol (meth)acrylate, phenol ethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, and polystyryl (meth)acrylate: those having a naphthalene ring, such as hydroxyethylated β-naphthol acrylate, 2-naphthoethyl (meth)acrylate, 2-naphthoxyethyl acrylate, and 2-(4-methoxy-1-naphthoxy)ethyl (meth)acrylate; and those having a biphenyl ring such as biphenyl (meth)acrylate. Particularly, the aromatic ring-containing (meth)acrylate is preferably benzyl (meth)acrylate and phenoxyethyl (meth)acrylate, and particularly preferably ethyl (meth)acrylate, from the viewpoints of adhesive properties and durability.

When the pressure-sensitive adhesive composition contains a crosslinking agent, these copolymerizable monomers are reaction points with the crosslinking agent. Particularly, the carboxy group-containing monomer and the hydroxy group-containing monomer have high reactivity with an intermolecular crosslinking agent, and are therefore preferably used to improve cohesiveness and heat resistance of the obtained pressure-sensitive adhesive layer.

The acrylic polymer contains a predetermined amount of each of the above monomers as the monomer unit in a mass proportion with respect to all monomers (100 mass %). The mass proportion of the alkyl (meth)acrylate can be set as the remainder of monomers other than the alkyl (meth)acrylate, and specifically, it is preferably 65 mass % or more, more preferably 70 mass % or more, still more preferably 75 mass % to 99.9 mass %, and particularly preferably 80 mass % to 99 mass %. It is preferable to set the mass proportion of the alkyl (meth)acrylate within the above range in order to ensure adhesiveness.

The acrylic polymer contains, as the monomer unit, monomers other than the alkyl (meth)acrylate in an amount of preferably 0.1 mass % or more, more preferably 0.2 mass % to 35 mass %, still more preferably 0.5 mass % to 30 mass %, and particularly preferably 1 mass % to 25 mass % in all monomers. When the mass proportion of the monomers other than the alkyl (meth)acrylate is 0.1 mass % or more, a crosslinking function and a cohesive force can be imparted. Particularly, when a monomer having a radically polymerizable functional group having a polymerizable unsaturated double bond such as a hydroxy group is contained, the resin composition is cured by heating, and peeling from the adherend is easy.

In the present invention, as the base polymer, an acrylic polymer having one or more radically polymerizable functional groups in one molecule can be used. When the acrylic polymer contains a plurality of radically polymerizable functional groups in one molecule, the types of the radically polymerizable functional groups may be same as or different from each other.

Examples of the radically polymerizable functional group include, but are not limited to, an ethylenically unsaturated group such as a (meth)acryloyl group, a vinyl group, and a styryl group.

Among them, the radically polymerizable functional group is preferably an ethylenically unsaturated group, and more preferably a (meth)acryloyl group, since polymerization can be easily controlled by a radical reaction. Examples of the (meth)acryloyl group include a (meth)acryloyloxy group (CH₂═CHCOO—(CH₂═C(CH₃)COO—)) and a (meth)acrylamide group.

When the acrylic polymer contains an ethylenically unsaturated group as the radically polymerizable functional group, the content of the ethylenically unsaturated group is preferably 0.1 mmol/g to 3.0 mmol/g, more preferably 0.5 mmol/g to 2.5 mmol/g, and still more preferably 1.0 mmol/g to 2.0 mmol/g.

The content of the radically polymerizable functional group in the acrylic polymer is measured by the following method when it is a (meth)acryloyl group.

First, 0.25 mg of a polymer to be measured is dissolved in 50 mL of THF (tetrahydrofuran), and 15 mL of methanol is further added to prepare a solution.

10 mL of a 4N sodium hydroxide aqueous solution is added to the prepared solution to obtain a mixed solution. Next, the above mixed solution is stirred at a liquid temperature of 40° C. for 2 hours. Further, 10.2 mL of a 4N methanesulfonic acid aqueous solution is added to the mixed solution, followed by stirring. Further, 5 mL of demineralized water is added to the mixed solution, followed by addition of 2 mL of methanol to prepare a measurement solution.

The content of (meth)acrylic acid in the measurement solution is measured by a HPLC (high performance liquid chromatography) method (absolute calibration curve method), and the content of the ethylenically unsaturated group is calculated.

HPLC measurement conditions
Column:
Synergi 4μ Polar-RP 80A (4.6 mm×250 mm), manufactured by Phenomenex Column temperature: 40° C.
Flow rate: 1.0 mL/min
Detector wavelength: 210 nm
Eluent: THF (tetrahydrofuran, for HPLC) 55/buffer water 45 (buffer water: 0.2%-phosphoric acid, 0.2%-triethylamine)
Aqueous solution injection amount: 5 μL

As a method for measuring the content of the ethylenically unsaturated group other than the (meth)acryloyl group, the bromine number is measured in accordance with JIS K2605:1996. Note that, the content of the ethylenically unsaturated group other than the (meth)acryloyl group is a value obtained by converting the number of grams (gBr₂/100 g) of bromine (Br₂) added per 100 g of a resin to be measured, which is obtained from the above bromine number, into the number of moles of bromine (Br₂) added per 1 g of resin.

For the purpose of improving the adhesiveness and the heat resistance, in addition to the above monomer units, one or more types of copolymerizable monomers having a polymerizable functional group having an unsaturated double bond such as a (meth)acryloyl group or a vinyl group can be introduced into the acrylic polymer by copolymerization.

Specific examples of such a copolymerizable monomer include: acid anhydride group-containing monomers such as maleic anhydride and itaconic anhydride; caprolactone adducts of acrylic acid: sulfonic acid group-containing monomers such as allylsulfonic acid, 2-(meth)acrylamido-2-methylpropanesulfonic acid, (meth)acrylamidopropanesulfonic acid, and sulfopropyl (meth)acrylate; and phosphoric acid group-containing monomers such as 2-hydroxyethyl acryloyl phosphate.

In addition, examples of monomers for the purpose of modification include: alkylaminoalkyl (meth)acrylates such as aminoethyl (meth)acrylate, N,N-dimethylaminoethyl (meth)acrylate, t-butylaminoethyl (meth)acrylate: alkoxyalkyl (meth)acrylates such as methoxyethyl (meth)acrylate and ethoxyethyl (meth)acrylate: succinimide-based monomers such as N-(meth)acryloyloxymethylene succinimide, N-(meth)acryloyl-6-oxyhexamethylene succinimide, and N-(meth)acryloyl-8-oxyoctamethylene succinimide: maleimide-based monomers such as N-cyclohexylmaleimide, N-isopropylmaleimide, N-laurylmaleimide, and N-phenylmaleimide; anditaconimide-based monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Further, examples of a modification monomer include: vinyl-based monomers such as vinyl acetate and vinyl propionate: cyanoacrylate-based monomers such as acrylonitrile and methacrylonitrile: epoxy group-containing (meth)acrylates such as glycidyl (meth)acrylate; glycol-based (meth)acrylates such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as tetrahydrofurfuryl (meth)acrylate, fluorine (meth)acrylate, silicone (meth)acrylate, and 2-methoxyethyl acrylate. Further examples include isoprene, butadiene, isobutylene, and vinyl ether.

Further, examples of a copolymerizable monomer other than those mentioned above include a silane-based monomer containing silicon atoms. Examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10 acryloyloxydecyltriethoxysilane.

In addition, examples of the copolymerizable monomer include: polyfunctional monomers having two or more unsaturated double bonds such as a (meth)acryloyl group or a vinyl group, such as esters of (meth)acrylic acid and a polyhydric alcohol, for example, tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and polyester (meth)acrylate, epoxy (meth)acrylate, and urethane (meth)acrylate having two or more unsaturated double bonds, such as a (meth)acryloyl group or a vinyl group, added as functional groups similar to monomer components in the skeleton of polyester, epoxy, and urethane.

The polymerization rate of the copolymerizable monomer in the acrylic polymer is preferably about 0 mass % to 10 mass %, more preferably about 0 mass % to 7 mass %, and still more preferably about 0 mass % to 5 mass %, in all monomers (100 mass %) of the acrylic polymer.

The acrylic polymer preferably has a weight average molecular weight (Mw) of 200,000 to 3,000,000. Considering the durability, particularly the heat resistance, the weight average molecular weight (Mw) is more preferably 400,000 to 2,500,000, and still more preferably 500,000 to 2,000,000. A weight average molecular weight (Mw) of less than 200,000 is not preferred from the viewpoint of the heat resistance. In addition, when the weight average molecular weight (Mw) is more than 3,000,000, the pressure-sensitive adhesive layer tends to be hard and peeling tends to occur. Note that, the weight average molecular weight (Mw) is measured by GPC (gel permeation chromatography) and determined based on the value calculated in terms of polystyrene.

The acrylic polymer for use in the present invention has a glass transition temperature (Tg) of preferably 0° C. or lower (usually −100° C. or higher), more preferably −5° C. or lower, and still more preferably −10° C. or lower. When the glass transition temperature is higher than 0° C., the cohesive force is increased and fluidity decreases, and a sufficient adhesive area may not be obtained and the adherend may not be fixed. Particularly, it is preferable that the Tg is −5° C. or lower because the acrylic polymer is soft and a sufficient peeling force can be obtained. Note that, the glass transition temperature of the acrylic polymer can be adjusted within the above range by appropriately changing the monomer components and composition ratio used. For the glass transition temperature of the acrylic polymer in the present invention, a measurement method using a dynamic viscoelasticity apparatus, a calculated value using the FOX formula or the like can be used.

For the production of such an acrylic polymer, known production methods such as solution polymerization, bulk polymerization, emulsion polymerization, and various radical polymerizations can be appropriately selected. The obtained acrylic polymer may be a random copolymer, a block copolymer, a graft copolymer, or the like.

Note that, in the solution polymerization, for example, ethyl acetate or toluene is used as a polymerization solvent. As a specific example of the solution polymerization, the reaction is carried out under a stream of an inert gas such as nitrogen, with the addition of a polymerization initiator, and generally at about 50° C. to 80° C. for about 1 to 8 hours, which are reaction conditions.

### (Thermally Polymerizable Material)

In the pressure-sensitive adhesive composition according to the present invention, when the base polymer contains a radically polymerizable functional group, the material having a radically polymerizable functional group can be the base polymer. When the base polymer does not contain a radically polymerizable functional group, a thermally polymerizable material is contained as the material having a radically polymerizable functional group.

Examples of the thermally polymerizable material include a monomer, an oligomer, and a polymer having a radically polymerizable functional group. These may be used alone or in combination of two or more types thereof.

Examples of the monomer having a radically polymerizable functional group include a polyfunctional acrylic having two or more unsaturated double bonds. A polyfunctional acrylic having one unsaturated double bond may be used in combination with the polyfunctional acryl having two or more unsaturated double bonds.

Examples of the polyfunctional acrylic include: bifunctional acrylics such as dipropylene glycol di(meth)acrylate, 1,6-hexanediol di(meth)acrylate, tripropylene glycol di(meth)acrylate, tripropylene glycol di(meth)acrylate, modified bisphenol A di(meth)acrylate, dimethyloldicyclopentadi(meth)acrylate, PEG400 di(meth)acrylate, PEG300 di(meth)acrylate, PEG600 di(meth)acrylate, and N,N′-methylenebisacrylamide; trifunctional acrylics such as trimethylolpropane tri(meth)acrylate, trimethylolpropane tri(meth)acrylate, trimethylolpropane ethoxytri(meth)acrylate, glycerin propoxytri(meth)acrylate, and pentaerythritol tri(meth)acrylate: tetrafunctional acrylics such as pentaerythritol ethoxytetra(meth)acrylate, ditrimethylolpropane tetra(meth)acrylate, pentaerythritol tetra(meth)acrylate, dipentaerythritol hexa(penta)(meth)acrylate, and dipentaerythritol monohydroxypenta(meth)acrylate; pentafunctional acrylics such as sorbitol pentaacrylate and dipentaerythritol pentaacrylate; hexafunctional acrylics such as dipentaerythritol hexaacrylate, sorbitol hexaacrylate, alkylene oxide-modified hexaacrylate, and caprolactone-modified dipentaerythritol hexaacrylate; and bifunctional or higher functional urethane acrylates.

The polyfunctional acrylic preferably has a weight average molecular weight (Mw) 100 to 100,000. When the weight average molecular weight (Mw) is within the above range, a thermal polymer can be cured.

The content of the thermally polymerizable material when the base polymer does not contain the material having a radically polymerizable functional group is preferably in the range of 20 to 100 parts by mass with respect to 100 parts by mass of the base polymer. When the thermally polymerizable material is contained in an amount of 20 parts by mass or more with respect to 100 parts by mass of the base polymer, the thermal polymer can be cured, making it easier to obtain the effects of the present invention. When the thermally polymerizable material is contained in an amount of 100 parts by mass or less, the peeling force before thermal polymerization can be maintained high. The content of the thermally polymerizable material is more preferably 30 parts by mass or more, still more preferably 40 parts by mass or more, and is more preferably 90 parts by mass or less, still more preferably 80 parts by mass or less, with respect to 100 parts by mass of the base polymer.

### (Thermal Polymerization Initiator)

The pressure-sensitive adhesive composition according to the present invention contains a thermal polymerization initiator that generates a radical by heating. Examples of such a thermal polymerization initiator include a peroxide, an azo-based compound, a dihalogen-based compound, an alkylphenone-based compound, and an acylphosphine oxide-based compound. Among them, a peroxide and an azo-based compound are preferred from the viewpoints of the durability and the price. The thermal polymerization initiator may be used alone or in combination of two or more types thereof.

Examples of the peroxide include benzoyl peroxide, 1,1-bis(t-hexylperoxy)cyclohexane, cyclohexanone peroxide, 3,3,5-trimethylcyclohexanone peroxide, methylcyclohexanone peroxide, 1,1-bis(t-butylperoxy)-3,3,5-trimethylcyclohexane, 1,1-bis(t-butylperoxy)cyclohexane, n-butyl-4,4-bis(t-butylperoxy) valerate, cumene hydroperoxide, 2,5-dimethylhexane-2,5-dihydroperoxide, 1,3-bis(t-butylperoxy)-m-isopropyl)benzene, 2,5-dimethyl-2,5-di(t-butylperoxy)hexane, diisopropylbenzene peroxide, t-butylcumyl peroxide, decanoyl peroxide, lauroyl peroxide, 2,4-dichlorobenzoyl peroxide, bis(t-butylcyclohexyl) peroxydicarbonate, t-butylperoxybenzoate, and 2,5-dimethyl-2,5-di(benzoylperoxy)hexane.

Examples of the azo-based compound include 2,2′-azobis(isobutyronitrile), 1,1-azobis(cyclohexane-1-carbonitrile), azocumene, 2,2′-azobis(2-methylbutyronitrile), 2,2′-azobisdimethylvaleronitrile, 4,4′-azobis(4-cyanovaleric acid), 2-(tert-butylazo)-2-cyanopropane, 2,2′-azobis(2,4,4-trimethylpentane), 2,2′-azobis(2-methylpropane), and dimethyl 2,2′-azobis(2-methylpropionate).

The thermal polymerization initiator for use in the present invention can be appropriately used as long as it generates radically active species by heating and promotes crosslinking of the base polymer of the pressure-sensitive adhesive composition. In consideration of workability and stability, those having a 1-minute half-life temperature of 100° C. to 150° C. are preferred. The 1-minute half-life temperature of the thermal polymerization initiator is more preferably 110° C. or higher, still more preferably 120° C. or higher, and is more preferably 140° C. or lower, still more preferably 135° C. or lower.

In addition, the thermal polymerization initiator preferably has a 10-hour half-life temperature of 60° C. to 100° C. from the viewpoints of production stability and storability of the obtained pressure-sensitive adhesive sheet. The 10-hour half-life temperature of the thermal polymerization initiator is more preferably 65° C. or higher, still more preferably 70° C. or higher, and is more preferably 95° C. or lower, still more preferably 90° C. or lower.

Note that, the half-life of the thermal polymerization initiator is an index representing the decomposition rate of the thermal polymerization initiator, and refers to the time it takes for the remaining amount of the thermal polymerization initiator to become half. The decomposition temperature to obtain a half-life in a given time and the half-life time at a given temperature are described in manufacturer catalogs or the like. For example, those for the peroxide are described in “Organic Peroxide Catalog 9th Edition (May 2003)” by NOF CORPORATION, and those for the azo-based compound are described on the homepage of FUJIFILM Wako Pure Chemical Corporation (https://specchem-wako-jp.fujifilm.com/azo/selection.htm).

In the present embodiment, the content of the thermal polymerization initiator is 1.2 to 10 parts by mass with respect to 100 parts by mass of all components excluding the thermal polymerization initiator. When the content of the thermal polymerization initiator is 1.2 parts by mass or more with respect to 100 parts by mass of all components excluding the thermal polymerization initiator, a rapid increase in adhesive force after a heat treatment can be prevented. When the content is 10 parts by mass or less, the peeling force before heating can be maintained high. The content of the thermal polymerization initiator is preferably 1.4 parts by mass or more, more preferably 1.7 parts by mass or more, still more preferably 2.0 parts by mass or more, even more preferably 2.5 parts by mass or more, and is preferably 7.0 parts by mass or less, more preferably 5.0 parts by mass or less.

### (Surfactant)

The pressure-sensitive adhesive composition according to the embodiment of the present invention preferably contains a surfactant. When a surfactant is contained, it is easier to control the adhesive force. Examples of the surfactant include a nonionic surfactant, an anionic surfactant, an amphoteric surfactant, and a cationic surfactant. Among them, a nonionic surfactant or an anionic surfactant is preferred, and a nonionic surfactant is more preferred. The surfactant may be used alone or in combination of two or more types thereof.

Examples of the nonionic surfactant include: polyoxyethylene alkyl ethers such as polyoxyethylene lauryl ether and polyoxyethylene stearyl ether: polyoxyethylene alkylphenyl ethers such as polyoxyethylene octylphenyl ether and polyoxyethylene nonylphenyl ether; sorbitan fatty acid esters such as sorbitan monolaurate, sorbitan monostearate, and polyoxyethylene sorbitan monolaurate: polyoxyethylene glyceryl ether fatty acid esters; and a polyoxyethylene-polyoxypropylene block copolymer.

Examples of the anionic surfactant include: alkyl sulfates such as lauryl sulfate and octadecyl sulfate: fatty acid salts: alkylbenzene sulfonates such as nonylbenzene sulfonate and dodecylbenzene sulfonate: naphthalene sulfonates such as dodecylnaphthalene sulfonate; alkyldiphenyl ether disulfonates such as dodecyl diphenyl ether disulfonate: polyoxyethylene alkyl ether sulfates such as polyoxyethylene octadecyl ether sulfate and polyoxyethylene lauryl ether sulfate: polyoxyethylene alkylphenyl ether sulfates such as polyoxyethylene lauryl phenyl ether sulfates: polyoxyethylene styrenated phenyl ether sulfates: sulfosuccinates such as lauryl sulfosuccinate and polyoxyethylene lauryl sulfosuccinate: polyoxyethylene alkyl ether phosphates; and polyoxyethylene alkyl ether acetates.

The content of the surfactant is preferably 0.1 to 10 parts by mass per 100 parts by mass of the base polymer. When the content of the surfactant is 0.1 parts by mass or more with respect to 100 parts by mass of the base polymer, peeling can be made with a small force during the peeling after heating. When the content is 10 parts by mass or less, the peeling force before heating can be maintained high. The content of the surfactant is more preferably 0.3 parts by mass or more, still more preferably 1 part by mass or more, and is more preferably 7 parts by mass or less, still more preferably 5 parts by mass or less.

### (Crosslinking Agent)

In the present embodiment, the pressure-sensitive adhesive composition may contain a crosslinking agent as necessary. The type of the crosslinking agent is not particularly limited, and can be appropriately selected from crosslinking agents known in the related art. Examples of such a crosslinking agent include an isocyanate-based crosslinking agent, an epoxy-based crosslinking agent, an oxazoline-based crosslinking agent, an aziridine-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, a hydrazine-based crosslinking agent, an amine-based crosslinking agent, and a silane coupling agent. Among them, an isocyanate-based crosslinking agent, an epoxy-based crosslinking agent, an oxazoline-based crosslinking agent, an aziridine-based crosslinking agent, and a melamine-based crosslinking agent are preferred, an isocyanate-based crosslinking agent and an epoxy-based crosslinking agent are more preferred, and an isocyanate-based crosslinking agent is particularly preferred. With the use of an isocyanate-based crosslinking agent, there is a tendency that impact resistance better than that of other crosslinking agents can be obtained while maintaining the cohesive force of the pressure-sensitive adhesive layer. Further, the use of an isocyanate-based crosslinking agent is advantageous in terms of improving the adhesive strength to an adherend made of a polyester resin such as PET. The crosslinking agent may be used alone or in combination of two or more types thereof.

As the isocyanate-based crosslinking agent, a polyfunctional isocyanate (referring to a compound having an average of two or more isocyanate groups per molecule, including those having an isocyanurate structure) can be preferably used.

Examples of the polyfunctional isocyanate include aliphatic polyisocyanates, alicyclic polyisocyanates, and aromatic polyisocyanates.

Specific examples of the aliphatic polyisocyanates include: 1,2-ethylene diisocyanate: tetramethylene diisocyanates such as 1,2-tetramethylene diisocyanate, 1,3-tetramethylene diisocyanate, and 1,4-tetramethylene diisocyanate: hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, and 2,5-hexamethylene diisocyanate: 2-methyl-1,5-pentane diisocyanate: 3-methyl-1,5-pentane diisocyanate; and lysine diisocyanate.

Specific examples of the alicyclic polyisocyanates include: isophorone diisocyanate; cyclohexyl diisocyanates such as 1,2-cyclohexyl diisocyanate, 1,3-cyclohexyl diisocyanate, and 1,4-cyclohexyl diisocyanate: cyclopentyl diisocyanates such as 1,2-cyclopentyl diisocyanate and 1,3-cyclopentyl diisocyanate: hydrogenated xylylene diisocyanate; hydrogenated tolylene diisocyanate: hydrogenated diphenylmethane diisocyanate; hydrogenated tetramethylxylene diisocyanate; and 4,4′-dicyclohexylmethane diisocyanate.

Specific examples of the aromatic polyisocyanates include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

As the isocyanate-based crosslinking agent, for example, commercially available products such as “Coronate L”, “Coronate HL”, and “Coronate HX” manufactured by Nippon Polyurethane Industries, Ltd. can be used.

The content of the crosslinking agent is preferably 0.01 to 10 parts by mass per 100 parts by mass of the base polymer. When the content of the crosslinking agent is 0.01 parts by mass or more with respect to 100 parts by mass of the base polymer, a cohesive force of a pressure-sensitive adhesive can be increased. When the content is 10 parts by mass or less, the peeling force before heating can be maintained high. The content of the crosslinking agent is more preferably 0.05 parts by mass or more, still more preferably 0.1 parts by mass or more, and is more preferably 7 parts by mass or less, still more preferably 5 parts by mass or less.

Further, the pressure-sensitive adhesive composition according to the present invention may contain other known additives. For example, polyether compounds of polyalkylene glycol such as polypropylene glycol, a colorant, a pigment powder, a dye, a plasticizer, a silane coupling agent, an adhesiveness imparting agent, a surface lubricant, a leveling agent, a softener, an anti-aging agent, an antioxidant, a light stabilizer, an ultraviolet absorber, a polymerization inhibitor, an inorganic or organic filler, a metal powder, particles, and a foil-like material can be used and added as appropriate depending on the application.

### [Pressure-Sensitive Adhesive Sheet]

A pressure-sensitive adhesive sheet according to the present invention includes a pressure-sensitive adhesive layer formed of the above pressure-sensitive adhesive composition on at least one side of a supporting substrate. Examples of a method for forming the pressure-sensitive adhesive layer include a method of applying a pressure-sensitive adhesive composition to a release liner or the like that has been subjected to a peeling treatment, drying and removing the polymerization solvent or the like to form a pressure-sensitive adhesive layer, and then transferring the pressure-sensitive adhesive layer to a supporting substrate, or a method of applying a pressure-sensitive adhesive composition to a supporting substrate, drying and removing the polymerization solvent or the like, and forming a pressure-sensitive adhesive layer on the supporting substrate. Note that, when applying the pressure-sensitive adhesive, one or more solvents other than the polymerization solvent may be added as appropriate.

The substrate that supports (backs) the pressure-sensitive adhesive layer is not particularly limited, and, for example, a resin film, paper, cloth, a rubber sheet, a foam sheet, a metal foil, or a composite thereof can be used. Examples of the resin film include: polyolefin films such as a polyethylene (PE), a polypropylene (PP), and an ethylene-propylene copolymer; polyester films such as polyethylene terephthalate (PET); a vinyl chloride resin film; a vinyl acetate resin film; a polyimide resin film; a polyamide resin film; a fluororesin film; and cellophane. Examples of the paper include Japanese paper, kraft paper, glassine paper, high quality paper, synthetic paper, and top coated paper. Examples of the cloth include woven fabrics and non-woven fabrics made of various fibrous substances alone or blended. Examples of the fibrous substances include cotton, a staple fiber, Manila hemp, pulp, rayon, an acetate fiber, a polyester fiber, a polyvinyl alcohol fiber, a polyamide fiber, and a polyolefin fiber. Examples of the rubber sheet include a natural rubber sheet and a butyl rubber sheet. Examples of the foam sheet include a foamed polyurethane sheet and a foamed polychloroprene rubber sheet. Examples of the metal foil include an aluminum foil and a copper foil.

Note that, the non-woven fabric here is a concept that refers to a non-woven fabric for pressure-sensitive adhesive sheets, which is mainly used in the field of pressure-sensitive adhesive tapes and other pressure-sensitive adhesive sheets, and refers to a non-woven fabric (sometimes referred to as “paper”) that is typically prepared using a general paper machine. In addition, the resin film here is typically a non-porous resin sheet, and is a concept that is distinguished from, for example, the non-woven fabric (that is, it does not include the non-woven fabric). The resin film may be an unstretched film, a uniaxially stretched film, or a biaxially stretched film.

The thickness of the supporting substrate is not particularly limited, and is preferably 5 μm to 200 μm from the viewpoint of preventing the pressure-sensitive adhesive sheet from being excessively thick. When the thickness of the supporting substrate is 5 μm or more, the pressure-sensitive adhesive sheet has excellent handling properties (handleability) and processability. In addition, when the thickness of the supporting substrate is 200 μm or less, it is possible to reduce the weight and the thickness of the pressure-sensitive adhesive sheet. The thickness of the supporting substrate is more preferably 7 μm or more, still more preferably 10 μm or more, and is more preferably 100 μm or less, still more preferably 50 μm or less.

As the release liner, a silicone release liner is preferably used. In the step of applying the pressure-sensitive adhesive composition according to the present invention on such a liner and performing drying to form a pressure-sensitive adhesive layer, an appropriate method may be adopted as a method for drying the pressure-sensitive adhesive depending on the purpose. Preferably, a method of heating and drying the coating film is used. The temperature in heating and drying is preferably 60° C. to 150° C., more preferably 70° C. to 130° C., and particularly preferably 80° C. to 120° C. When the heating temperature is within the above range, a pressure-sensitive adhesive having excellent adhesive properties can be obtained.

As the drying time, an appropriate time can be adopted as needed. The drying time is preferably 1 minute to 10 minutes, more preferably 2 minutes to 7 minutes, and particularly preferably 3 minutes to 5 minutes.

In addition, the pressure-sensitive adhesive layer can be formed on the surface of the substrate after forming an anchor layer or a surface treatment layer or performing various adhesion-promoting treatments such as a corona treatment and a plasma treatment. The surface of the pressure-sensitive adhesive layer may be subjected to an adhesion-promoting treatment.

Various methods can be used as the method for forming the pressure-sensitive adhesive layer. Specific examples thereof include methods such as an extrusion coating method using a roll coat, a kiss roll coat, a gravure coat, a reverse coat, a roll brush, a spray coat, a dip roll coat, a bar coat, a knife coat, an air knife coat, a curtain coat, a lip coat, and a die coater.

The thickness of the pressure-sensitive adhesive layer is not particularly limited, and is preferably 2 μm to 200 μm from the viewpoint of preventing the pressure-sensitive adhesive sheet from being excessively thick. When the thickness of the pressure-sensitive adhesive layer is 2 μm or more, adhesion to the adherend is ensured and the impact resistance is easily obtained. In addition, when the thickness of the pressure-sensitive adhesive layer is 200 μm or less, it is possible to reduce the weight and the thickness of the pressure-sensitive adhesive sheet. The thickness of the pressure-sensitive adhesive layer is more preferably 5 μm or more, still more preferably 10 μm or more, and is more preferably 100 μm or less, still more preferably 50 μm or less.

When the pressure-sensitive adhesive layer is exposed after being formed on the supporting substrate, the pressure-sensitive adhesive layer may be protected with a sheet (separator) subjected to a peeling treatment until the pressure-sensitive adhesive layer is put into practical use.

### [Peeling Method for Pressure-Sensitive Adhesive Sheet]

The pressure-sensitive adhesive sheet can be used for various applications, for example, heat-resistant pressure-sensitive adhesive tapes such as a heat-resistant masking tape and an industrial tape, heat-resistant pressure-sensitive adhesive tapes such as a semiconductor tape, and heat-resistant pressure-sensitive adhesive tapes such as an optical tape.

Examples of the adherend include optical glass plates such as an anhydrous alkali glass, metal layers such as an ITO layer, metal plates, synthetic resin plates, synthetic resin films, and synthetic resin sheets, but are not particularly limited.

The pressure-sensitive adhesive sheet according to the present invention can exhibit easy peelability immediately after heating, and when the adherend to which the pressure-sensitive adhesive sheet is bonded is subjected to a heat treatment at 160° C. to 250° C. for 3 minutes to 5 hours without a prior heat treatment at 100° C. or higher, and then the adherend and the pressure-sensitive adhesive sheet are peeled at an interface therebetween, the pressure-sensitive adhesive sheet can be peeled from the adherend. Therefore, in a case where a heat treatment is performed at a temperature of 160° C. or higher in the production of various industrial products, when the pressure-sensitive adhesive sheet according to the present invention is bonded to a portion to be avoided from direct heating, during the heat treatment, the adherend is protected, and after the heat treatment, the pressure-sensitive adhesive sheet can be peeled from the surface of the adherend with a small peeling force.

The temperature in the heat treatment is more preferably 170° C. to 250° C., and still more preferably 170° C. to 200° C., and the time in the heat treatment is more preferably 5 minutes to 5 hours, and still more preferably 10 minutes to 3 hours.

### EXAMPLES

Hereinafter, the present invention will be further described with reference to Examples and Comparative Examples, but the present invention is not limited to the following Examples.

### <Preparation of Acrylic Polymer A>

To a reaction vessel equipped with a cooling tube, a nitrogen introduction tube, a thermometer, and a stirring device, 85 parts by mass of 2-methoxyethyl acrylate (hereinafter referred to as “MEA”), 15 parts by mass of acryloylmorpholine (hereinafter referred to as “ACMO”), 20 parts by mass of 2-hydroxyethyl acrylate (hereinafter referred to as “HEA”), 0.2 parts by mass of benzoyl peroxide, and 65 parts by mass of toluene were charged, and a polymerization treatment was carried out at 61° C. for 6 hours in a nitrogen stream to obtain an acrylic polymer a.

2-Methacryloyloxyethyl isocyanate (hereinafter referred to as “MOI”) was added to this acrylic polymer a in an amount of 75 mol % with respect to HEA, and an addition reaction treatment was carried out at 50° C. for 48 hours in an air stream to obtain an acrylic polymer A having a structure shown below. Note that, in the following structure, k, 1, m, and n were the mass ratios of respective monomers, and k=61, 1=11, m=25, and n=4. In addition, the weight average molecular weight (Mw) of the acrylic polymer A was 600,000.

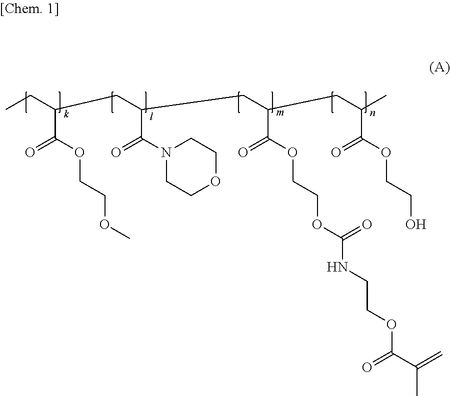

### <Preparation of Acrylic Polymer B>

To a reaction vessel equipped with a cooling tube, a nitrogen introduction tube, a thermometer, and a stirring device, 85 parts by mass of lauryl methacrylate (hereinafter referred to as “LMA”), 15 parts by mass of 2-hydroxyethyl methacrylate (hereinafter referred to as “HEMA”), 0.2 parts by mass of benzoyl peroxide, and 65 parts by mass of toluene were charged, and a polymerization treatment was carried out at 61° C. for 6 hours in a nitrogen stream to obtain an acrylic polymer b.

MOI was added to this acrylic polymer b in an amount of 67 mol % with respect to HEMA, and an addition reaction treatment was carried out at 50° C. for 48 hours in an air stream to obtain an acrylic polymer B having a structure shown below. Note that, in the following structure, l, m, and n were the mass ratios of respective monomers, and 1=76, m=20, and n=4. In addition, the weight average molecular weight (Mw) of the acrylic polymer B was 500,000.

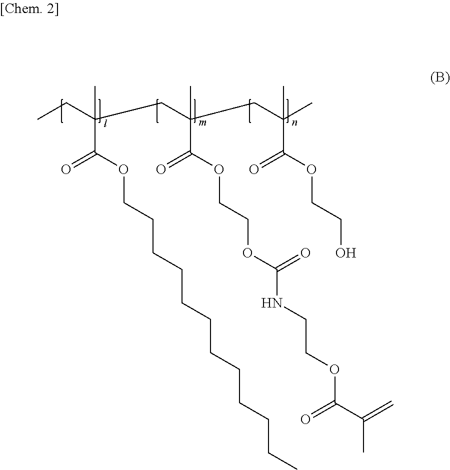

### <Preparation of Acrylic Polymer C>

To a reaction vessel equipped with a cooling tube, a nitrogen introduction tube, a thermometer, and a stirring device, 35 parts by mass of 2-ethylhexyl acrylate (hereinafter referred to as “2EHA”), 67 parts by mass of methyl acrylate (hereinafter referred to as “MA”), 8 parts by mass of acrylic acid (hereinafter referred to as “AA”), 0.2 parts by mass of benzoyl peroxide, and 65 parts by mass of toluene were charged, and a polymerization treatment was carried out at 61° C. for 6 hours in a nitrogen stream to obtain an acrylic polymer C having a structure shown below. Note that, in the following structure, 1, m, and n were the mass ratios of respective monomers, and 1=32, m=61, and n=7. In addition, the weight average molecular weight (Mw) of the acrylic polymer C was 900,000.

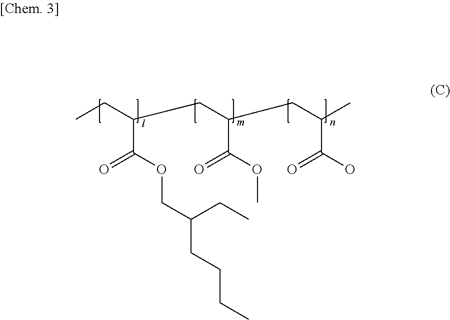

### <Preparation of Acrylic Polymer D>

To a reaction vessel equipped with a cooling tube, a nitrogen introduction tube, a thermometer, and a stirring device, 95 parts by mass of n-butyl acrylate (hereinafter referred to as “BA”), 5 parts by mass of AA, 0.2 parts by mass of benzoyl peroxide, and 65 parts by mass of toluene were charged, and a polymerization treatment was carried out at 61° C. for 6 hours in a nitrogen stream to obtain an acrylic polymer D having a structure shown below. Note that, in the following structure, m and n were the mass ratios of respective monomers, and m=95, and n=5. In addition, the weight average molecular weight (Mw) of the acrylic polymer D was 600,000.

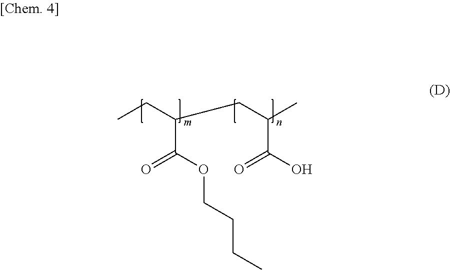

### <Preparation of Pressure-Sensitive Adhesive Sheet 1>

To 100 parts by mass of the acrylic polymer A, 1 part by mass of a polyisocyanate compound (product name “Coronate L”, manufactured by Nippon Polyurethane Industries, Co., Ltd.), and 5 parts by mass of polyoxyethylene sorbitan monolaurate (product name “RHEODOL TW-L120”, manufactured by Kao Corporation) as a nonionic surfactant were added. To 100 parts by mass of this mixture, 1.4 parts by mass of benzoyl peroxide (product name “NYPER BW”, manufactured by NOF CORPORATION) was added as a thermal polymerization initiator to prepare a pressure-sensitive adhesive solution.

The obtained pressure-sensitive adhesive solution was applied onto a silicone-treated surface of a PET release liner and heated at 80° C. for 5 minutes to form a pressure-sensitive adhesive layer having a thickness of 10 μm. Next, a PET film having a thickness of 12 μm was bonded to the surface of the pressure-sensitive adhesive layer. Thereafter, it was stored at 50° C. for 24 hours to prepare a pressure-sensitive adhesive sheet 1.

During the formation of the pressure-sensitive adhesive layer (heating at 80° C.), the pressure-sensitive adhesive layer could be formed without curing and was not cured even when stored at 50° C., and both the formability and the storability of the pressure-sensitive adhesive sheet were good.

### <Preparation of Pressure-Sensitive Adhesive Sheet 2>

A pressure-sensitive adhesive sheet 2 was prepared in the same manner as the pressure-sensitive adhesive sheet 1, except that the amount of the thermal polymerization initiator added was changed to 3 parts by mass, unlike in the preparation of the pressure-sensitive adhesive sheet 1.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 3>

A pressure-sensitive adhesive sheet 3 was prepared in the same manner as the pressure-sensitive adhesive sheet 1, except that the amount of the thermal polymerization initiator added was changed to 5 parts by mass, unlike in the preparation of the pressure-sensitive adhesive sheet 1.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 4>

A pressure-sensitive adhesive sheet 4 was prepared in the same manner as the pressure-sensitive adhesive sheet 2, except that the acrylic polymer A was changed to the acrylic polymer B, unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 5>

A pressure-sensitive adhesive sheet 5 was prepared in the same manner as the pressure-sensitive adhesive sheet 2, except that the acrylic polymer A was changed to the acrylic polymer C, and 70 parts by mass of dipentaerythritol hexaacrylate (DPHA) as a polyfunctional acrylic was added with respect to 100 parts by mass of the acrylic polymer C, unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 6>

A pressure-sensitive adhesive sheet 6 was prepared in the same manner as the pressure-sensitive adhesive sheet 2, except that the thermal polymerization initiator was changed to 1,1-bis(t-hexylperoxy)cyclohexane (product name “PERHEXA HC”, manufactured by NOF CORPORATION), unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 7>

A pressure-sensitive adhesive sheet 7 was prepared in the same manner as the pressure-sensitive adhesive sheet 2, except that no surfactant was added, unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 8>

A pressure-sensitive adhesive sheet 8 was prepared in the same manner as the pressure-sensitive adhesive sheet 2, except that the surfactant was changed to 0.3 parts by mass of polyoxyalkylene alkyl ether (product name “NAROACTY ID-60”, manufactured by SANYO CHEMICAL INDUSTRIES, LTD.), unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 9>

A pressure-sensitive adhesive sheet 9 was prepared in the same manner as the pressure-sensitive adhesive sheet 2, except that the amount of the surfactant added was changed to 10 parts by mass, unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 10>

A pressure-sensitive adhesive sheet 10 was prepared in the same manner as the pressure-sensitive adhesive sheet 2, except that the thermal polymerization initiator was changed to bis(4-t-butylcyclohexyl) peroxydicarbonate (product name “PEROYL TCP”, manufactured by NOF CORPORATION), unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 11>

A pressure-sensitive adhesive sheet 11 was prepared in the same manner as the pressure-sensitive adhesive sheet 2, except that the thermal polymerization initiator was changed to t-hexyl peroxypivalate (product name “PERHEXYL PV”, manufactured by NOF CORPORATION), unlike in the preparation of the pressure-sensitive adhesive sheet 2.

During both the formation of the pressure-sensitive adhesive layer (heating at 80° C.) and the storage at 50° C., the pressure-sensitive adhesive layer was not cured, and both the formability and the storability of the pressure-sensitive adhesive sheet were good.

### <Preparation of Pressure-Sensitive Adhesive Sheet 12>

A pressure-sensitive adhesive sheet 12 was prepared in the same manner as the pressure-sensitive adhesive sheet 2, except that the acrylic polymer A was changed to the acrylic polymer D, unlike in the preparation of the pressure-sensitive adhesive sheet 2.

During the formation of the pressure-sensitive adhesive layer (heating at 80° C.), a decrease in initial peeling force due to heat curing was observed. The storability during the storage at 50° C. was good.

### <Preparation of Pressure-Sensitive Adhesive Sheet 13>

A pressure-sensitive adhesive sheet 13 was prepared in the same manner as the pressure-sensitive adhesive sheet 1, except that the amount of the thermal polymerization initiator added was changed to 1 part by mass, unlike in the preparation of the pressure-sensitive adhesive sheet 1.

During the formation of the pressure-sensitive adhesive layer (heating at 80° C.), the formability was good, but during the storage at 50° C., a decrease in initial peeling force due to heat curing was observed.

### Example 1

The pressure-sensitive adhesive sheet 1 was cut into a strip having a width of 20 mm and a length of 100 mm, the strip was pasted on an alkali glass plate (thickness: 1.35 mm, polished blue plate edge product) manufactured by Matsunami Glass Ind., Ltd. using a roller (a pressure force of 2 kg/10 mm), and an autoclave treatment was performed at 50° C. and 5 atm for 30 minutes, followed by being left to stand at normal temperature and pressure for 30 minutes, to obtain a test specimen.

The test specimen was subjected to peeling at a peeling angle of 180 degrees and a peeling speed of 300 mm/min, and the peeling force was measured using TENSILON (EZ-S 500N manufactured by SHIMADZU) (initial peeling force).

In addition, the test specimen was subjected to a heat treatment in an oven at 180° C. for 1 hour, and left to stand at normal temperature and pressure for 30 minutes, and then the peeling force was measured in the same manner (post-heating peeling force).

### Examples 2 to 9

Operations same as in Example 1 were performed except that the pressure-sensitive adhesive sheet 1 was respectively changed to the pressure-sensitive adhesive sheets 2 to 9, unlike in Example 1.

### Example 10

An operation same as in Example 1 was performed except that the heat treatment conditions for the test specimen were changed to 160° C. for 3 hours, unlike in Example 1.

### Example 11

An operation same as in Example 1 was performed except that the heat treatment conditions for the test specimen were changed to 230° C. for 5 minutes, unlike in Example 1.

### Examples 12 and 13

Operations same as in Example 1 were performed except that the pressure-sensitive adhesive sheet 1 was respectively changed to the pressure-sensitive adhesive sheets 10 and 11, unlike in Example 1.

### Comparative Examples 1 and 2

Operations same as in Example 1 were performed except that the pressure-sensitive adhesive sheet 1 was respectively changed to the pressure-sensitive adhesive sheets 12 and 13, unlike in Example 1.

### <Peeling Force Evaluation>

The peeling forces measured before and after heating (the initial peeling force and the post-heating peeling force) were compared. A case where the value after heating is twice or less the value before heating is determined as “A” that light peeling is possible, and a case where the value after heating is more than twice the value before heating is determined as “B” that light peeling is not possible.

The results are shown in Table 1.

TABLE 1

| | | Thermal polymerization initiator | | | Thermally | | | | | |
|---|---|---|---|---|---|---|---|---|---|---|
| | | Type/content | | | polymerizable | | | Adhesive force | | |
| | | (with respect | | | material | Surfactant | | | Post- | |
| | | to all components | 1-minute | 10-hour | Type/content | Type/content | Heating | initial | heating | |
| | Base | excluding thermal | half-life | half-life | (with respect | (with respect | temperature | debonding | debonding | |
| | polymer | polymerization | temp- | temp- | to base | to base | and heating | (N/ | force | Eval- |
| | Type | initiator) | erature | erature | polymer) | polymer) | time | 20 mm) | (N/20 mm) | uation |
| Example 1 | (A) | Benzoyl peroxide | 130° C. | 74° C. | — | RHEODOL | 180° C. | 2.3 | 4.3 | A |
| | | 1.4 parts | | | | TW-L120 | and 1 h | | | |
| | | | | | | 5 parts | | | | |
| Example 2 | (A) | Benzoyl perioxide | 130° C. | 74° C. | — | RHEODOL | 180° C. | 2.1 | 0.2 | A |
| | | 3 parts | | | | TW-L120 | and 1 h | | | |
| | | | | | | 5 parts | | | | |
| Example 3 | (A) | Benzoyl perioxide | 130° C. | 74° C. | — | RHEODOL | 180° C. | 1.8 | 0.1 | A |
| | | 5 parts | | | | TW-L120 | and 1 h | | | |
| | | | | | | 5 parts | | | | |
| Example 4 | (B) | Benzoyl perioxide | 130° C. | 74° C. | — | RHEODOL | 180° C. | 1.0 | 0.1 | A |
| | | 5 parts | | | | TW-L120 | and 1 h | | | |
| | | | | | | 5 parts | | | | |
| Example 5 | (C) | Benzoyl perioxide | 130° C. | 74° C. | Polyfunctional | RHEODOL | 180° C. | 5.1 | 2.6 | A |
| | | 3 parts | | | acrylic | TW-L120 | and 1 h | | | |
| | | | | | 70 parts | 5 parts | | | | |
| Example 6 | (A) | 1,1-Bis(t-hexyl- | 149° C. | 87° C. | — | RHEODOL | 180° C. | 2.2 | 1.5 | A |
| | | peroxy)cyclohexane | | | | TW-L120 | and 1 h | | | |
| | | 3 parts | | | | 5 parts | | | | |
| Example 7 | (A) | Benzoyl peroxide | 130° C. | 74° C. | — | — | 180° C. | 5.6 | 4.0 | A |
| | | 3 parts | | | | | and 1 h | | | |
| Example 8 | (A) | Benzoyl peroxide | 130° C. | 74° C. | — | NAROACTY | 180° C. | 5.0 | 1.8 | A |
| | | 3 parts | | | | ID-60 | and 1 h | | | |
| | | | | | | 0.3 parts | | | | |
| Example 9 | (A) | Benzoyl peroxide | 130° C. | 74° C. | — | RHEODOL | 180° C. | 1.0 | 0.2 | A |
| | | 3 parts | | | | TW-L120 | and 1 h | | | |
| | | | | | | 10 parts | | | | |
| Example 10 | (A) | Benzoyl peroxide | 130° C. | 74° C. | — | RHEODOL | 160° C. | 2.1 | 1.1 | A |
| | | 3 parts | | | | TW-L120 | and 3 h | | | |
| | | | | | | 5 parts | | | | |
| Example 11 | (A) | Benzoyl peroxide | 130° C. | 74° C. | — | RHEODOL | 230° C. | 2.1 | 0.4 | A |
| | | 3 parts | | | | TW-L120 | and 5 min | | | |
| | | | | | | 5 parts | | | | |
| Example 12 | (A) | Bis(4-t-butylcyclo- | 92° C. | 41° C. | — | RHEODOL | 180° C. | 0.2 | 0.2 | A |
| | | hexyl)peroxy- | | | | TW-L120 | and 1 h | | | |
| | | dicarbonate | | | | 5 parts | | | | |
| | | 3 parts | | | | | | | | |
| Example 13 | (A) | t-Hexyl | 109° C. | 53° C. | — | RHEODOL | 180° C. | 2.1 | 0.1 | A |
| | | peroxypivelate | | | | TW-L120 | and 1 h | | | |
| | | 3 parts | | | | 5 parts | | | | |
| Comparative | (D) | Benzoyl peroxide | 130° C. | 74° C. | — | RHEODOL | 180° C. | 4.5 | 13.0 | A |
| Example 1 | | 3 parts | | | | TW-L120 | and 1 h | | | |
| | | | | | | 5 parts | | | | |
| Comparative | (A) | Benzoyl peroxide | 130° C. | 74° C. | — | RHEODOL | 180° C. | 2.2 | 13.2 | A |
| Example 2 | | 1 part | | | | TW-L120 | and 1 h | | | |
| | | | | | | 5 parts | | | | |

As seen from the results in Table 1, in all of Examples 1 to 13, the post-heating peeling force is less than twice the initial peeling force, and is 5 N/20 mm or less. From this, it is found that the pressure-sensitive adhesive sheet can be peeled with a small peeling force in the case of peeling after heating. In contrast, it is found that, in Comparative Example 1 in which the pressure-sensitive adhesive composition does not contain the material having a radically polymerizable functional group and Comparative Example 2 in which the content of the thermal polymerization initiator is 1 part by mass even when the pressure-sensitive adhesive composition contains the material having a radically polymerizable functional group, the post-heating peeling force is much more than twice the value of the initial peeling force, and is 13 N/20 mm or more, indicating that a large load is applied to the peeling.

While the present invention has been described in detail with reference to specific embodiments, it will be apparent to those skilled in the art that various changes and modifications can be made without departing from the spirit and scope of the present invention. The present application is based on a Japanese Patent Application (No. 2021-160103) filed on Sep. 29, 2021, the contents of which are incorporated herein by reference.

1. A pressure-sensitive adhesive composition comprising:
a material having a radically polymerizable functional group; and
a thermal polymerization initiator that generates a radical, wherein
a content of the thermal polymerization initiator is 1.2 to 10 parts by mass with respect to 100 parts by mass of all components excluding the thermal polymerization initiator.

2. The pressure-sensitive adhesive composition according to claim 1, wherein the thermal polymerization initiator contains at least one of a peroxide and an azo-based compound.

3. The pressure-sensitive adhesive composition according to claim 1, wherein the thermal polymerization initiator has a 1-minute half-life temperature of 100° C. to 150° C.

4. The pressure-sensitive adhesive composition according to claim 1, wherein the thermal polymerization initiator has a 10-hour half-life temperature of 60° C. to 100° C.

5. The pressure-sensitive adhesive composition according to claim 1, wherein the material having a radically polymerizable functional group is at least one of a polymer having a radically polymerizable functional group and a monomer having a radically polymerizable functional group.

6. The pressure-sensitive adhesive composition according to claim 1, wherein the radically polymerizable functional group is a (meth)acryloyl group.

7. The pressure-sensitive adhesive composition according to claim 5, wherein the polymer having a radically polymerizable functional group is contained as a base polymer.

8. The pressure-sensitive adhesive composition according to claim 7, wherein the base polymer is an acrylic polymer.

9. The pressure-sensitive adhesive composition according to claim 1, further comprising a surfactant.

10. The pressure-sensitive adhesive composition according to claim 9, wherein the surfactant is a nonionic surfactant.

11. A pressure-sensitive adhesive sheet comprising:
a pressure-sensitive adhesive layer formed of the pressure-sensitive adhesive composition according to claim 1.

12. A peeling method for peeling the pressure-sensitive adhesive sheet according to claim 11 which is bonded to an adherend, the peeling method comprising:
subjecting the adherend to which the pressure-sensitive adhesive sheet is bonded to a heat treatment at 160° C. to 250° C. for 3 minutes to 5 hours without a prior heat treatment at 100° C. or higher, and then peeling the adherend and the pressure-sensitive adhesive sheet at an interface therebetween.
